(19) United States
(12) Patent Application Publication
(10) Pub. No.: US 2012/0203525 A1
(43) Pub. Date: Aug. 9, 2012

(54) THREE-DIMENSIONAL MODELING OF PARAMETERS FOR OILFIELD DRILLING

(76) Inventors: ADRIAN RODRIGUEZ HERRERA, BRACKNELL (GB); NIKOLAOS CONSTANTINOS KOUTSABELOULIS, WINKFIELD-WINDSOR (GB)

(21) Appl. No.: 13/368,519

(22) Filed: Feb. 8, 2012

Related U.S. Application Data
(60) Provisional application No. 61/440,620, filed on Feb. 8, 2011.

(51) Int. Cl. G06F 17/10

(52) U.S. Cl. 703/2

(57) ABSTRACT

A method for three-dimensional modeling of parameters for oilfield drilling. The method includes generating a three-dimensional model of an underground geological region, receiving a starting point for the oilfield drilling, calculating, using the three-dimensional model and an objective function, a drilling direction from the starting point, calculating, using the three-dimensional model, drilling densities for drilling from the starting point, and presenting the drilling direction and the drilling densities.

### CROSS-REFERENCE TO RELATED APPLICATIONS

This application claims benefit under 35 U.S.C. §119(e) of U.S. Provisional Patent Application Ser. No. 61/440,620 filed on Feb. 8, 2011, which is hereby incorporated by reference.

### BACKGROUND

Operations, such as surveying, drilling, wireline testing, completions, production, planning and field analysis, are typically performed to locate and gather valuable downhole fluids. Surveys are performed using acquisition methodologies, such as seismic scanners or surveyors to obtain data about underground formations. During drilling and production operations, data is typically collected for analysis and/or monitoring of the operations. Such data may include, for instance, information regarding subterranean formations, equipment, historical, and/or other data. Typically, simulators use the gathered data to model specific behavior of discrete portions of the wellbore operation.

### SUMMARY

In general in one aspect, embodiments relate to a method for three-dimensional modeling of parameters for oilfield drilling. The method includes generating a three-dimensional model of an underground geological region, receiving a starting point for the oilfield drilling, calculating, using the three-dimensional model and an objective function, a drilling direction from the starting point, calculating, using the three-dimensional model, drilling densities for drilling from the starting point, and presenting the drilling direction and the drilling densities.

In general, in one aspect, embodiments relate to a system for three-dimensional modeling of parameters for oilfield drilling. The system includes an oilfield three-dimensional simulator application and an oilfield analysis application. The oilfield three-dimensional simulator application is configured to generate a three-dimensional model of an underground geological region. The oilfield analysis application is configured to receive a starting point for the oilfield drilling, calculate, using the three-dimensional model and an objective function, a drilling direction from the starting point, calculate, using the three-dimensional model, drilling densities for drilling from the starting point, and present the drilling direction and the drilling densities.

In general, in one aspect, embodiments relate to a computer readable medium that includes computer readable program code embodied therein for causing a computer system to perform a method for three-dimensional modeling of parameters for oilfield drilling. The method includes generating a three-dimensional model of an underground geological region, receiving a starting point for the oilfield drilling, calculating, using the three-dimensional model and an objective function, a drilling direction from the starting point, calculating, using the three-dimensional model, drilling densities for drilling from the starting point, and presenting the drilling direction and the drilling densities.

This summary is provided to introduce a selection of concepts that are further described below in the detailed description. This summary is not intended to identify key or essential features of the claimed subject matter, nor is it intended to be used as an aid in limiting the scope of the claimed subject matter. Other aspects will be apparent from the following description and the appended claims.

### BRIEF DESCRIPTION OF DRAWINGS

FIG. 1 shows an example system in which embodiments of three-dimensional modeling may be implemented.

FIG. 2 shows an example system in which embodiments of three-dimensional modeling may be implemented.

FIG. 3 shows an example computer system in which embodiments of three-dimensional modeling may be implemented.

FIG. 4 shows an example system in which embodiments of three-dimensional modeling may be implemented.

FIG. 5 shows an example method for three-dimensional modeling in one or more embodiments.

FIG. 6 shows an example method of calculating drilling direction for three-dimensional modeling in one or more embodiments.

FIG. 7 shows an example method of calculating drilling densities for three-dimensional modeling in one or more embodiments.

FIGS. 8.1-8.4 show example graphical diagrams in one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments provide a method and apparatus for three-dimensional modeling of parameters for oilfield drilling. Specifically, embodiments generate a three-dimensional model of an underground geological region. Using the three-dimensional model, embodiments calculate an optimal drilling direction and drilling densities from a provided starting point in the underground geological region. The drilling direction and drilling densities may be used to drill a well in the oilfield. For example, embodiments may drill the well by transmitting the drilling direction and drilling densities to a surface unit that sends a signal to a drilling tool with the drilling direction and drilling densities.

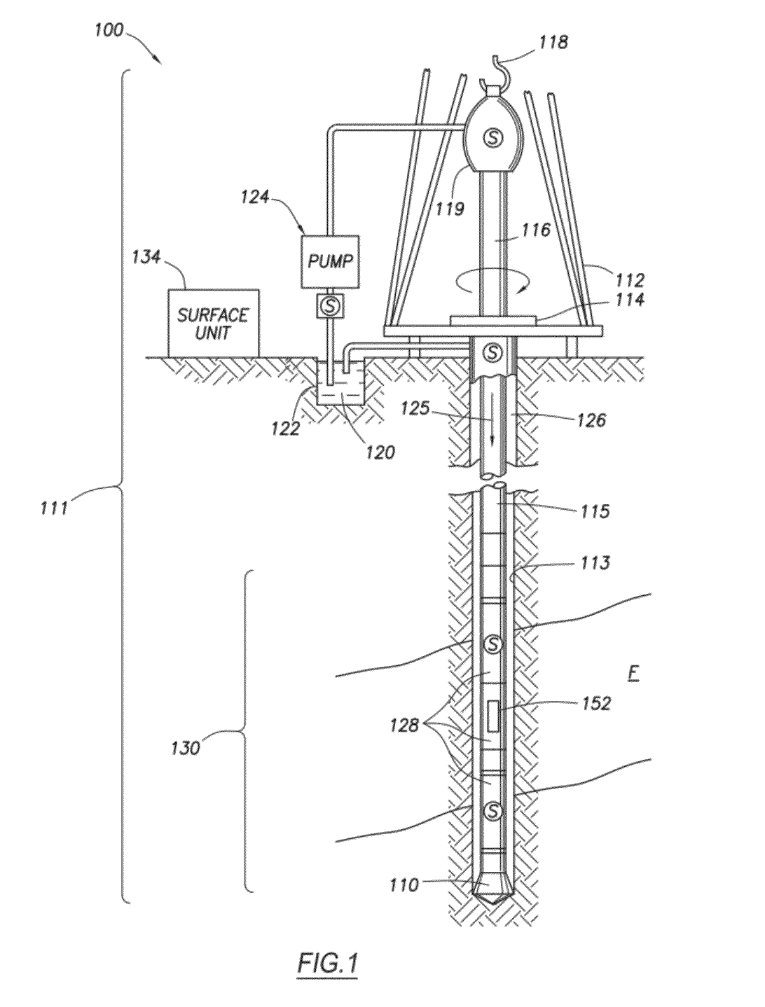

FIG. 1 shows an example system in which embodiments of three-dimensional modeling may be implemented. Specifically, FIG. 1 is a schematic view of a wellsite (100) depicting a drilling operation. In one or more embodiments, drilling tools are deployed from the oil and gas rigs. The drilling tools advanced into the earth along a path to locate reservoirs containing the valuable downhole assets. In one or more embodiments, the optimal path for the drilling is identified using the three-dimensional modeling. Specifically, in one or more embodiments, the three-dimensional model is partitioned into a three-dimensional grid of cells. Each cell may be a cube in the model. In one or more embodiments, a drilling direction is calculated for each cell in the model while accounting for neighboring cells. The path is defined by drilling in the drilling direction from a starting cell to a neighboring cell, then drilling in the drilling direction defined for the neighboring cell to a subsequent neighboring cell, then drilling in the drilling direction for the subsequent neighboring cell to another neighboring cell, etc.

Fluid, such as drilling mud or other drilling fluids, is pumped down the wellbore (or borehole) through the drilling tool and out the drilling bit. In one or more embodiments, the amount of fluid pumped into the well is defined by the drilling density. Specifically, the drilling density is the upper and lower bounds of equivalent hydraulic pressure acting over borehole walls to create failure of the borehole. Because the amount and type of fluid directly affects the hydraulic pressure on the borehole walls, calculating the drilling density and using the drilling density defines the amount and type of fluid to pump down the wellbore. Continuing with the discussion of FIG. 1, the drilling fluid flows through the annulus between the drilling tool and the wellbore and out the surface, carrying away earth loosened during drilling. The drilling fluids return the earth to the surface, and seal the wall of the wellbore to prevent fluid in the surrounding earth from entering the wellbore and causing a ‘blow out’.

During the drilling operation, the drilling tool may perform downhole measurements to investigate downhole conditions. The drilling tool may be used to take core samples of subsurface formations. In some cases, the drilling tool is removed and a wireline tool is deployed into the wellbore to perform additional downhole testing, such as logging or sampling. Steel casing may be run into the well to a desired depth and cemented into place along the wellbore wall. Drilling may be continued until the desired total depth is reached.

A formation is in an underground geological region. An underground geological region is a geographic area that exists below land or ocean. In one or more embodiments, the underground geological region includes the subsurface formation in which a borehole is or may be drilled and any subsurface region that may affect the drilling of the borehole, such as because of stresses and strains existing in the subsurface region. In other words, the underground geological region may not only include the area immediately surrounding a borehole or where a borehole may be drilled, but also any area that affects or may affect the borehole or where the borehole may be drilled.

After the drilling operation is complete, the well may then be prepared for production. Wellbore completions equipment is deployed into the wellbore to complete the well in preparation for the production of fluid through the wellbore. Fluid is then allowed to flow from downhole reservoirs, into the wellbore and to the surface. Production facilities are positioned at surface locations to collect the hydrocarbons from the wellsite(s). Fluid drawn from the subterranean reservoir(s) passes to the production facilities via transport mechanisms, such as tubing. Various equipments may be positioned about the oilfield to monitor oilfield parameters, to manipulate the oilfield operations and/or to separate and direct fluids from the wells. Surface equipment and completion equipment may also be used to inject fluids into reservoir either for storage or at strategic points to enhance production of the reservoir.

During the oilfield operations, data is typically collected for analysis and/or monitoring of the oilfield operations. Such data may include, for example, subterranean formation, equipment, historical and/or other data. Data concerning the subterranean formation is collected using a variety of sources. Such formation data may be static or dynamic. Static data relates to, for example, formation structure and geological stratigraphy that define the geological structures of the subterranean formation. Dynamic data relates to, for example, fluids flowing through the geologic structures of the subterranean formation over time. Such static and/or dynamic data may be collected to learn more about the formations and the valuable assets contained therein. Specifically, the static and dynamic data collected from the wellbore and the oilfield may be used to create and update the three-dimensional model. Additionally, static and dynamic data from other wellbores or oilfields may be used to create and update the three-dimensional model. Hardware sensors, core sampling, and well logging techniques may be used to collect the data. Other static measurements may be gathered using downhole measurements, such as core sampling and well logging techniques. Well logging involves deployment of a downhole tool into the wellbore to collect various downhole measurements, such as density, resistivity, etc., at various depths. Such well logging may be performed using, for example, the drilling tool and/or a wireline tool. Once the well is formed and completed, fluid flows to the surface using production tubing and other completion equipment. As fluid passes to the surface, various dynamic measurements, such as fluid flow rates, pressure, and composition may be monitored. These parameters may be used to determine various characteristics of the subterranean formation.

Continuing with FIG. 1, the wellsite system (100) includes a drilling system (111) and a surface unit (134). In the illustrated embodiment, a borehole (113) is formed by rotary drilling in a manner that is well known. Although rotary drilling is shown, embodiments also include drilling applications other than conventional rotary drilling (e.g., mud-motor based directional drilling), and is not limited to land-based rigs. For example, embodiments may be used to perform three-dimensional modeling and drilling of a deep water operation.

The drilling system (111) includes a drill string (115) suspended within the borehole (113) with a drill bit (110) at its lower end. The drilling system (111) also includes the land-based platform and derrick assembly (112) positioned over the borehole (113) penetrating a subsurface formation (F). The assembly (112) includes a rotary table (114), kelly (116), hook (118) and rotary swivel (119). The drill string (115) is rotated by the rotary table (114), energized by means not shown, which engages the kelly (116) at the upper end of the drill string. The drill string (115) is suspended from hook (118), attached to a traveling block (also not shown), through the kelly (116) and a rotary swivel (119) which permits rotation of the drill string relative to the hook.

The drilling system (111) further includes drilling fluid or mud (120) stored in a pit (122) formed at the well site. A pump (124) delivers the drilling fluid (120) to the interior of the drill string (115) via a port in the swivel (119), inducing the drilling fluid to flow downwardly through the drill string (115) as indicated by the directional arrow (125). The drilling fluid exits the drill string (115) via ports in the drill bit (110), and then circulates upwardly through the region between the outside of the drill string and the wall of the borehole, called the annulus (126). In this manner, the drilling fluid lubricates the drill bit (110) and carries formation cuttings up to the surface as it is returned to the pit (122) for recirculation.

The drill string (115) further includes a bottom hole assembly (BHA), generally referred to as (130), near the drill bit (110) (in other words, within several drill collar lengths from the drill bit). The bottom hole assembly (130) includes capabilities for measuring, processing, and storing information, as well as communicating with the surface unit. The BHA (130) further includes drill collars (128) for performing various other measurement functions.

Sensors (S) are located about the wellsite to collect data, may be in real time, concerning the operation of the wellsite, as well as conditions at the wellsite. The sensors may also have features or capabilities, of monitors, such as cameras (not shown), to provide pictures of the operation. Surface sensors or gauges S may be deployed about the surface systems to provide information about the surface unit, such as standpipe pressure, hook load, depth, surface torque, rotary rpm, among others. Downhole sensors or gauges (S) are disposed about the drilling tool and/or wellbore to provide information about downhole conditions, such as wellbore pressure, weight on bit, torque on bit, direction, inclination, collar rpm, tool temperature, annular temperature, and toolface, among others. The information collected by the sensors and cameras is conveyed to the various parts of the drilling system and/or the surface control unit.

The drilling system (110) is operatively connected to the surface unit (134) for communication therewith. The BHA (130) is provided with a communication subassembly (152) that communicates with the surface unit (134). The communication subassembly (152) is adapted to send signals to and receive signals from the surface using mud pulse telemetry. The communication subassembly may include, for example, a transmitter that generates a signal, such as an acoustic or electromagnetic signal, which is representative of the measured drilling parameters. Communication between the downhole and surface systems is depicted as being mud pulse telemetry. However, a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may deviate from the drilling plan. Additionally, as drilling or other operations are performed, the subsurface conditions may change. The three-dimensional model may also be adjusted as new information is collected, such as from sensors. Specifically, as new information is collected, the sensors may transmit data to the surface unit. The surface unit may automatically use the data to update the three-dimensional model.

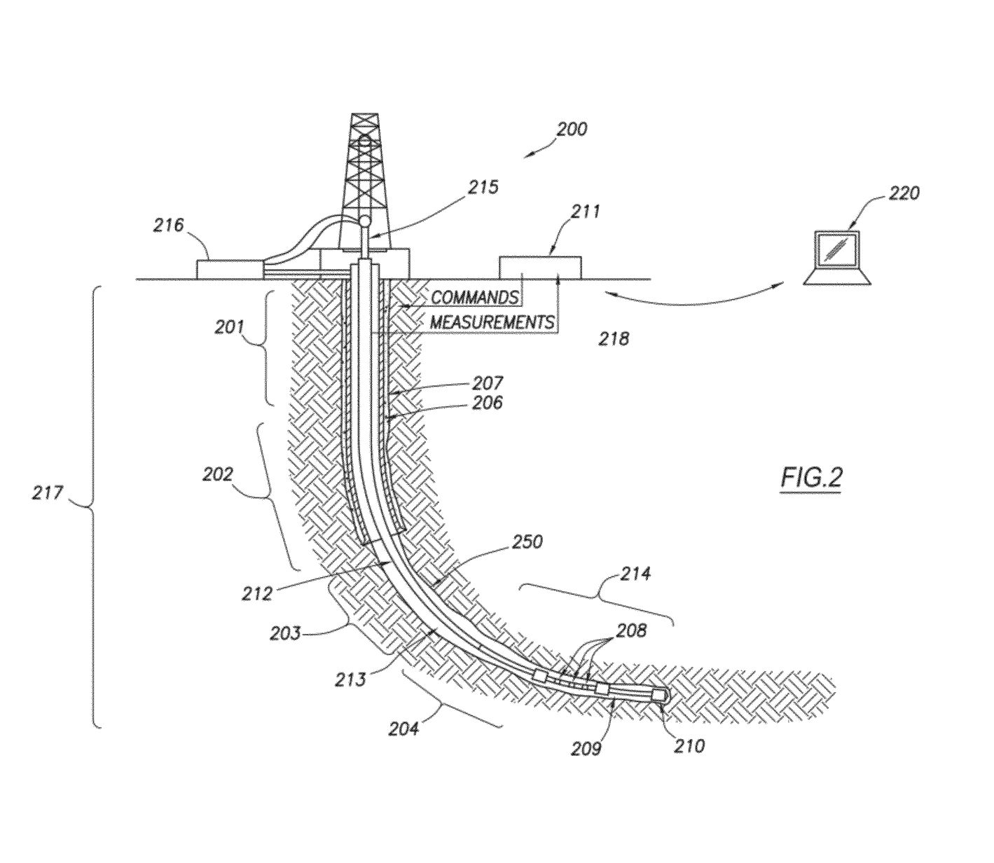

FIG. 2 shows a schematic diagram depicting drilling operation of a directional well in multiple sections. The drilling operation depicted in FIG. 2 includes a wellsite drilling system (200) and a computer system (220) for accessing fluid in the target reservoir through a bore hole (250) of a directional well (217). The wellsite drilling system (200) includes various components (e.g., drill string (212), annulus (213), bottom hole assembly (BHA) (214), Kelly (215), mud pit (216), etc.) as generally described with respect to the wellsite drilling systems (100) (e.g., drill string (115), annulus (126), bottom hole assembly (BHA) (130), Kelly (116), mud pit (122), etc.) of FIG. 1 above. As shown in FIG. 2, the target reservoir may be located away from (as opposed to directly under) the surface location of the well (217). Accordingly, special tools or techniques may be used to ensure that the path along the bore hole (250) reaches the particular location of the target reservoir (200).

For example, the BHA (214) may include sensors (208), rotary steerable system (209), and the bit (210) to direct the drilling toward the target guided by a pre-determined survey program for measuring location details in the well. Furthermore, the subterranean formation through which the directional well (217) is drilled may include multiple layers (not shown) with varying compositions, geophysical characteristics, and geological conditions. Both the drilling planning during the well design stage and the actual drilling according to the drilling plan in the drilling stage may be performed in multiple sections (e.g., sections (201), (202), (203), (204)) corresponding to the multiple layers in the subterranean formation. For example, certain sections (e.g., sections (201) and (202)) may use cement (207) reinforced casing (206) due to the particular formation compositions, geophysical characteristics, and geological conditions.

Further as shown in FIG. 2, surface unit (211) (as generally described with respect to the surface unit (134) of FIG. 1) may be operatively linked to the wellsite drilling system (200) and the computer system (220) via communication links (218). The surface unit (211) may be configured with functionalities to control and monitor the drilling activities by sections in real-time via the communication links (218). The computer system (220) may be configured with functionalities to store oilfield data (e.g., historical data, actual data, surface data, subsurface data, equipment data, geological data, geophysical data, target data, anti-target data, etc.) and determine relevant factors for configuring a drilling model and generating a drilling plan. The oilfield data, the drilling model, and the drilling plan may be transmitted via the communication link (218) according to a drilling operation workflow. The communication link (218) may comprise the communication subassembly (352) as described with respect to FIG. 1 above.

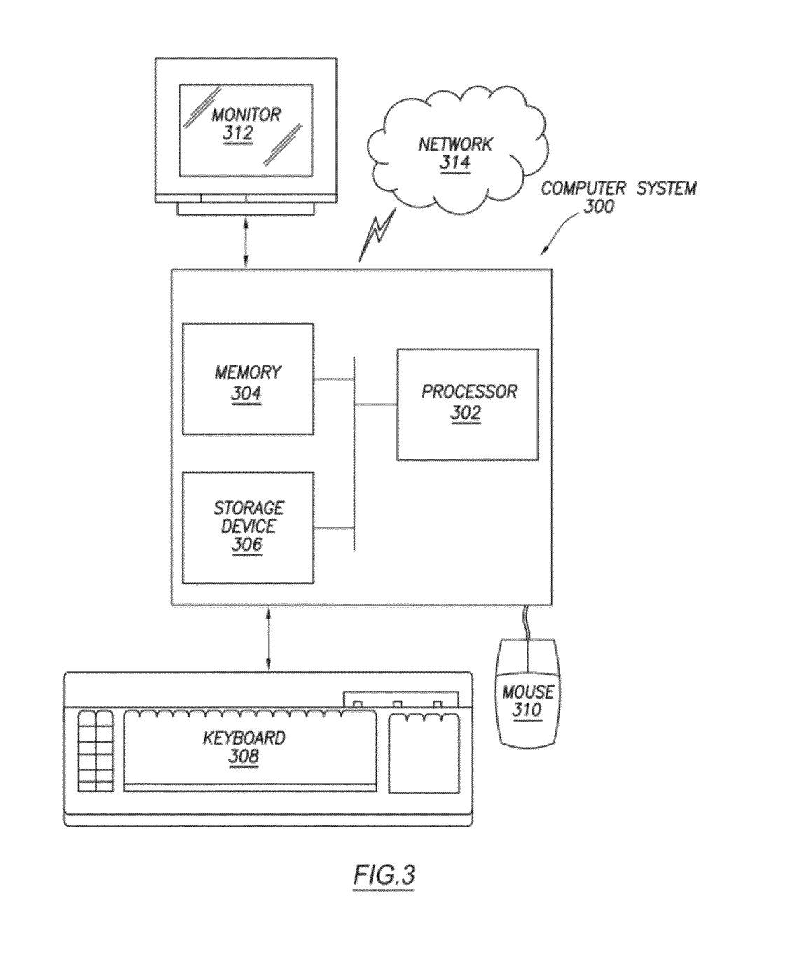

The computer system (220 in FIG. 2) may be virtually any type of computer regardless of the platform being used. For example, as shown in FIG. 3, a computer system (220) includes one or more hardware processor(s) (302), associated memory (304) (e.g., random access memory (RAM), cache memory, flash memory, etc.), a storage device (306) (e.g., a hard disk, an optical drive such as a compact disk drive or digital video disk (DVD) drive, a flash memory stick, etc.), and numerous other elements and functionalities typical of today's computers (not shown). The computer (300) may also include input means, such as a keyboard (308), a mouse (310), or a microphone (not shown). Further, the computer (300) may include output means, such as a monitor (312) (e.g., a liquid crystal display (LCD), a plasma display, or cathode ray tube (CRT) monitor). The computer system (300) may be connected to a network (314) (e.g., a local area network (LAN), a wide area network (WAN) such as the Internet, or any other type of network) via a network interface connection (not shown). Those skilled in the art will appreciate that many different types of computer systems exist, and the aforementioned input and output means may take other forms. Generally speaking, the computer system (220) includes at least the minimal processing, input, and/or output means necessary to practice embodiments.

Further, one or more elements of the aforementioned computer system (220) may be located at a remote location and connected to the other elements over a network. Further, embodiments may be implemented on a distributed system having a multiple nodes, where each portion of embodiments of three-dimensional modeling (e.g., reservoir simulator, geomechanical simulator, oilfield analysis application, oilfield three-dimensional simulation application, storage repository, etc.) may be located on a different node within the distributed system. In one embodiment, the node corresponds to a computer system. Alternatively, the node may correspond to a processor with associated physical memory. The node may alternatively correspond to a processor or micro-core of a processor with shared memory and/or resources.

Further, computer readable program code to perform one or more of the various components of the system may be stored, permanently or temporarily, in whole or in part, on a non-transitory computer readable medium such as a compact disc (CD), a diskette, a tape, physical memory, or any other physical computer readable storage medium that includes functionality to store computer readable program code to perform embodiments. In one or more embodiments, the computer readable program code is configured to perform embodiments when executed by a processor(s).

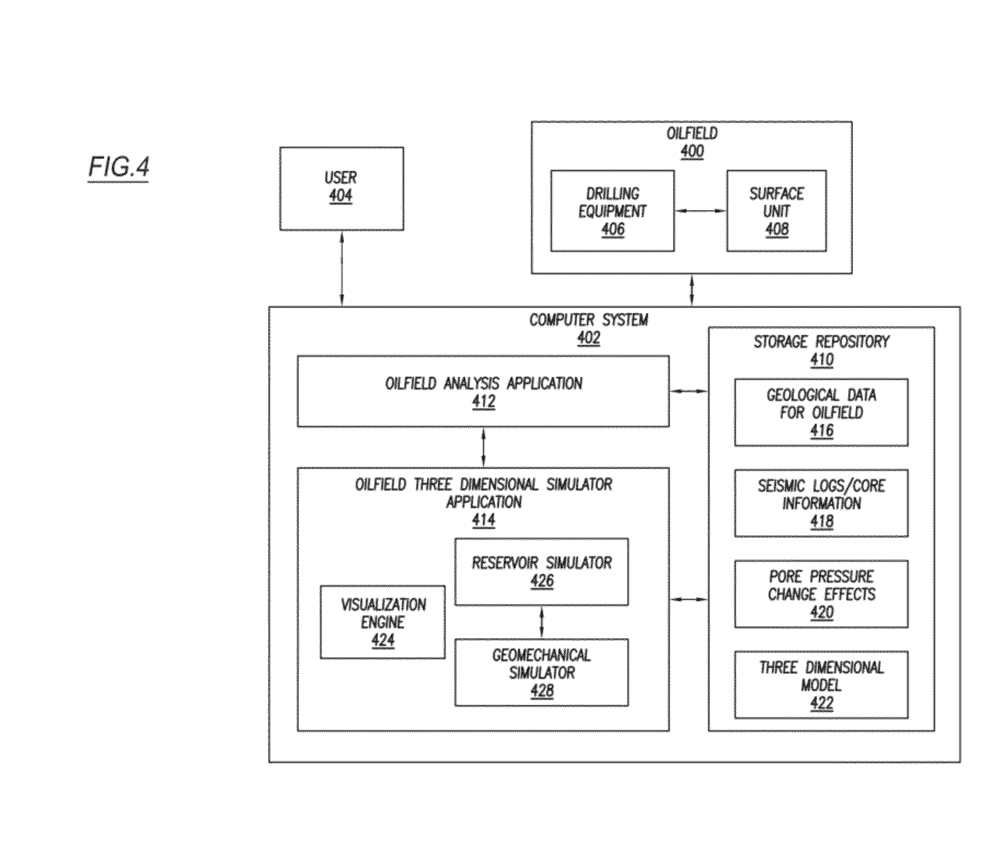

FIG. 4 shows an example computer system (402) in which embodiments of three-dimensional modeling may be implemented. Specifically, the computer system (402) shown in FIG. 4 may be the computer system shown in FIG. 3. As shown in FIG. 4 and discussed above, the computer system (402) may be operatively connected to the oilfield (400). In other words, the computer system (402) may be directly or indirectly connected to the oilfield (400) using one or more communication links. Communication links include functionality to transmit data (e.g., sensor data and execution conditions) from the oilfield (400) to the computer system (402) and data (e.g., commands, parameters, etc.) from the computer system (402) to the oilfield (400). The oilfield (400) includes drilling equipment (406) and a surface unit (408). The drilling equipment (406) may include the components of FIGS. 1 and 2 corresponding to equipment for drilling the borehole (e.g., mud pit, kelly, bottom hole assembly, sensors, rotary swivel, drill collars, communication sub assembly, etc.). As discussed above with respect to FIGS. 1 and 2, the drilling equipment (406) is operatively connected to the surface unit (408). The surface unit (408) may be the surface unit discussed above with reference to FIGS. 1 and 2.

Continuing with FIG. 3, the computer system (402) may also include functionality, such as through one or more software and hardware user interfaces, to communicate with user (404). User (404) may be, for example, a geological engineer, a drilling engineer, or another person that provides input to the computer system and receives output. The computer system (402) includes a storage repository (410), an oilfield analysis application (412), and an oilfield three-dimensional model (414) in one or more embodiments.

The storage repository (410) is any type of storage unit and/or device (e.g., a file system, database, collection of tables, or any other storage mechanism) for storing data. Further, the storage repository (410) may include multiple different storage units and/or devices. The multiple different storage units and/or devices may or may not be of the same type or located at the same physical site. In one or more embodiments of the invention, the storage repository (410), or a portion thereof, is secure.

The storage repository (410) includes functionality to store geological data for the oilfield (416), seismic logs and/or core information (418), pore pressure change effects (420), and a three-dimensional model (422). Geological data (416) includes data regarding the type of rock and minerals in the formation, layout of the rock and other minerals in the formation, existing stresses and fractures, porosity of the rock, hydraulic conditions, geologic and structural features, and other geological information about the underground geological region.

In one or more embodiments, seismic logs and/or core information include information gathered while performing surveying operations of the geological region. For example, as discussed above, seismic logs may include data gathered by a seismic truck that transmits sound vibrations. The sound vibrations reflect off of horizons in a formation. The reflected sound vibration(s) is (are) received in by sensors, such as geophone-receivers, situated on the earth's surface, and the sensors produce electrical output signals (e.g., seismic logs) that may automatically be populated into the storage repository (410).

In one or more embodiments, core information is information gathered by taking a physical sample (i.e., core sample) of the geological region. For example, core information may include the density, porosity, permeability or other physical property of the core sample over the length of the core sample. Core information may also include indirect information, such as by performing tests for density and viscosity on the fluids in the core sample at varying pressures and temperatures.

In one or more embodiments, pore pressure change effects are estimated reductions or increases in pore pressure that may be caused by either injections or depletions. Pore pressure is the amount of force being exerted into the borehole by fluid and/or gases within the geological region. In one or more embodiments, pore pressure change effects (420) corresponds to output from the reservoir simulator (426) (discussed below) and may be used as input to the geomechanical simulator (428).

In one or more embodiments, the three-dimensional model (422) models the geographic region, including providing information about stresses, strains, and deformations, geologic structures and features, temperature and pressure information, and other such information. As discussed above, the three-dimensional model (422) is partitioned into three-dimensional cells. The three-dimensional model (422) reflects how changes in each cell affects other cells in the model.

Continuing with FIG. 4, the storage repository is connected to an oilfield analysis application (412) and an oilfield three-dimensional simulator application (414) in one or more embodiments. The oilfield analysis application (412) is a software application that includes functionality to analyze an oilfield. For example, the oilfield analysis application may include functionality to prepare received data for the simulators. Specifically, the oilfield analysis application (412) includes functionality to access data in the storage repository (410) and to populate the storage repository (410). Populating the storage repository (410) may include obtaining sensor data from the oilfield (400), performing preprocessing on the sensor data, and storing the preprocessed sensor data in the storage repository (410).

The oilfield analysis application (412) may further include functionality to analyze output data from the oilfield three-dimensional simulator application (414). For example, the oilfield analysis application (412) may include functionality to perform additional simulations, such as by simulating an oilfield network of wellsites where wells are interconnected by pipes.

In one or more embodiments, the oilfield, three-dimensional simulator application (414) includes functionality to construct the three-dimensional model (422) and identify drilling direction and drilling densities using the three-dimensional model (428). The oilfield three-dimensional simulator application (414) includes a visualization engine (424), a reservoir simulator (426), and a geomechanical simulator (428).

The visualization engine (424) is a user interface that allows the user to interact with the three-dimensional model. For example, using the visualization engine (424), the user may expand and rotate the three-dimensional model, analyze particular cells of the three-dimensional model, and view different types of data presented in the three-dimensional model. Further, using the visualization engine (424), the user may adjust data in the three-dimensional model. For example, if the user has particular knowledge of a stress or strain in the geologic region that is not reflected in the three-dimensional model, then visualization engine (424) provides graphical functionality for the user may adjust the three-dimensional model. Additionally, in one or more embodiments, the visualization engine (424) includes functionality to display a proposed path of the wellbore through the three-dimensional model as defined by the drilling direction and drilling densities. With the proposed path, the visualization engine may also show stresses, strains, and deformations in the geological region that are preexistent and stresses, strains, and deformations that may result by drilling the proposed path using the drilling densities.

The reservoir simulator (426) includes functionality to generate the three-dimensional model. Specifically, the reservoir simulator includes functionality to generate an initial three-dimensional model that shows stresses, strains, and deformations, compare the three-dimensional model with observed conditions of the wellbore or other similar wellsites, and calibrate the three-dimensional model to match the observed conditions. In one or more embodiments, the reservoir simulator (426) includes functionality to simulate the changes in pore pressure caused by injections and/or depletions of the reservoir.

The geomechanical simulator (428) includes functionality to use the three-dimensional model to calculate the optimal drilling direction and drilling densities. Specifically, the geomechanical simulator (428) includes functionality to identify based on the stresses, strains, and deformations, an optimal path in the three-dimensional model. The geomechanical simulator (428) further includes functionality to calculate drilling densities for fluid or gas pumped into the wellbore to prevent collapse of the wellbore. The geomechanical simulator (428) includes functionality to perform the aforementioned tasks while simultaneously accounting for the geological conditions of the surrounding region.

While FIGS. 1-4 show a configuration of components, other configurations may be used without departing from the scope of three-dimensional modeling. For example, various components may be combined to create a single component. As another example, the functionality performed by a single component may be performed by two or more components.

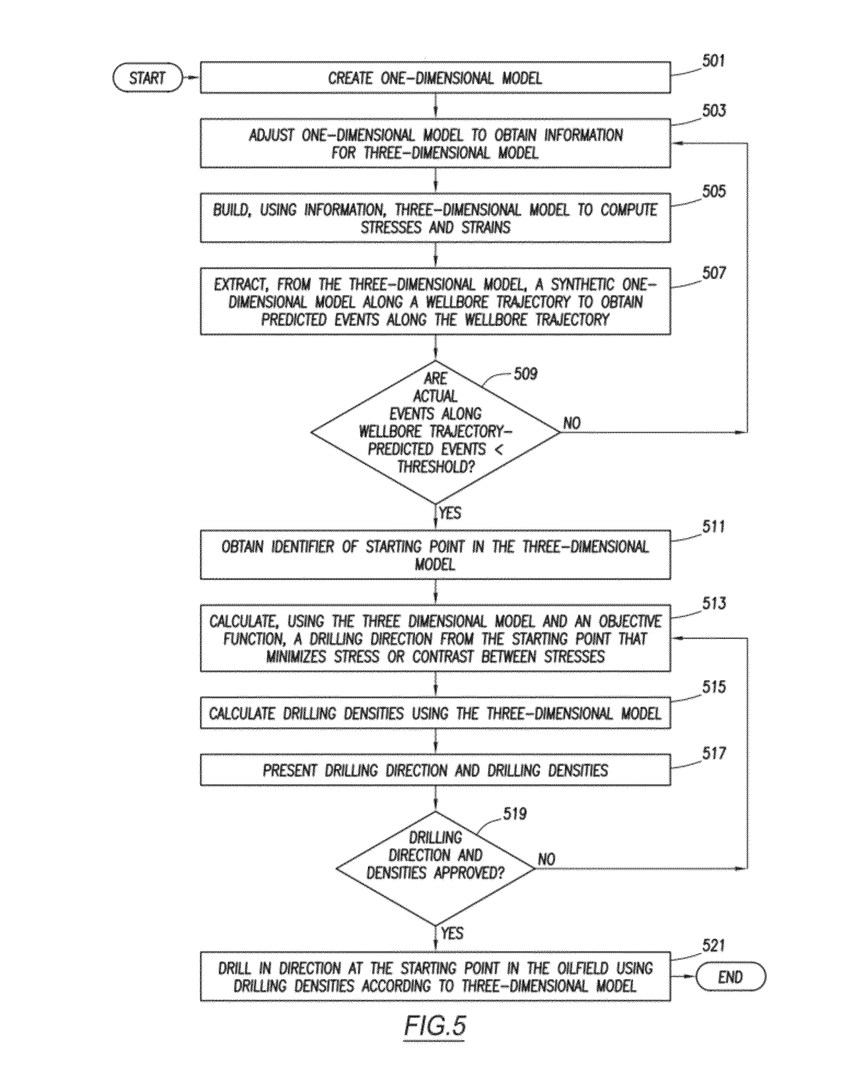

FIGS. 5-7 show flowcharts in one or more embodiments of three-dimensional modeling. While the various components in these flowcharts are presented and described sequentially, one of ordinary skill will appreciate that some or all of the components may be executed in different orders, may be combined or omitted, and some or all of the components may be executed in parallel. Furthermore, the components may be performed actively or passively. For example, some components may be performed using polling or be interrupt driven in accordance with one or more embodiments of the invention. By way of an example, a determination may not require a processor to process an instruction unless an interrupt is received to signify that condition exists in accordance with one or more embodiments of the invention. As another example, a determination may be performed by performing a test, such as checking a data value to test whether the value is consistent with the tested condition in accordance with one or more embodiments.

FIG. 5 shows a flowchart for three-dimensional modeling in one or more embodiments. In FIG. 5, components 501-509 show generating a three-dimensional model in one or more embodiments. Components 511-521 show using the three-dimensional model in one or more embodiments.

In 501, a one dimensional model is created in one or more embodiments. A one-dimensional model is a model of stresses, strains, and deformations only along a particular path of a wellbore. In one or more embodiments, the one-dimensional model does not account for stresses or strains outside of the path of the wellbore. Creating the one dimensional model may be performed by simulating the effects of drilling in a particular drilling direction on the formation. Stress modeling along a well may be performed by using analytical equations that, based on the rock elastic properties, produces a stress profile that transforms the acting vertical stress (a function of depth and rock density) into horizontal stress (the rock elastic properties related the acting vertical stress and pore pressure with the acting horizontal stresses). Once the stress profile is obtained, well failure may be computed based on additional rock strength properties. The well stress profile or rock properties are adjusted until the predicted wellbore failures match the observed (e.g., after logging the well) failures the well experienced during drilling.

In 503, the one dimensional model is adjusted to obtain information for the three-dimensional model in one or more embodiments. In 505, using the information, the three-dimensional model is built to compute stresses and strains in one or more embodiments. Specifically, the three-dimensional model concatenates data from the seismic logs and cores, the geological data, and the information gathered from the one-dimensional model. The simulator may use industry standard concepts and formulae along with other algorithms to model rock formation behavior based on existing observational data. For example, the Finite Element Method (FEM) is a technique of numerical analysis in which a continuum is represented as a series of discrete elements represented by nodes and volumes. The simulator engine may apply FEM techniques to problems of stress in geo-mechanics. The simulator computes stress effects across a continuous rock formation by perform multiple calculations for points and volumes in an imaginary three-dimensional mesh (grid).

In 507, from the three-dimensional model, a synthetic one-dimensional model is extracted along a wellbore trajectory (i.e., path of existing wellbore) to obtain predicted events along the wellbore trajectory. In particular, an actual wellbore from an existing oilfield is identified. The actual wellbore may be, for example, near the wellbore to be drilled or a first part of a wellbore to be drilled. The position of the actual wellbore trajectory with respect to the three-dimensional model is identified. For example, the coordinates of the actual wellbore with respect to the earth may be identified. Based on the coordinates, the synthetic wellbore trajectory that matches the coordinates in the three-dimensional model is identified and extracted. The synthetic wellbore trajectory includes predicted events, such as stresses and strains in the geological region that occur naturally or would be caused by the drilling of the wellbore. At each depth of interest along a well, such as every ten meters along a well, the well location in three-dimensional (3D) space is used to search for the cell (i.e., element) of the 3D model that contains such point. Once found, the stress, pore pressure and rock mechanical data (elastic and failure parameters) may be assigned to the wellbore at searched location. Once this action is performed along the whole interest interval, the well contains sufficient data for any process involving the computation of wellbore stability.

In 509, a determination is made whether the predicted events are within a threshold of the actual events along the existing wellbore trajectory. Specifically, a determination is made as to whether the synthetic wellbore trajectory accurately captures actual data gathered from an existing wellbore trajectory. By comparing the actual events with predicted events, the accuracy of the three-dimensional model may be determined.

By way of an example, consider the scenario in which an actual event shows that a particular region of the wellbore shows a stress of a particular magnitude. In the example, the same particular region in the synthetic one dimensional model may not have a stress or may show a stress of considerably lower magnitude than the one in the actual event. In such a scenario, the predicted events may be determined to not be within the threshold of the actual events. As another example, the predicted events may show one or more stresses or strains that are not in the actual events. In such a scenario, the predicted events may be determined to not be within the threshold of the actual events.

In contrast, as another example, if most or all of the predicted events are in the actual events and of the same magnitude, and most or all of the actual events are reflected in the predicted events and of the same magnitude, then the three-dimensional model may be determined to be accurate.

In 509, if the predicted events are not within a threshold of the actual events along the existing wellbore trajectory, the flow may proceed to 503. If the predicted events are not within a threshold of the actual events along the existing wellbore trajectory, the flow may proceed to 511.

In 511, an identifier of the starting point in the three-dimensional model is obtained. The starting point is the point in the oilfield from which the drilling direction and drilling densities are defined. For example, if drilling of a borehole has not started, the starting point may be at the surface of the earth at a particular geographic location (e.g., specified by longitude and latitude, Geopositioning system coordinates, or other coordinates). As another example, if the drilling of a borehole is in progress, or the first part of the drilling of the borehole is already planned, the starting point may be below the surface of the earth. In such a scenario, the starting point may be specified, for example, by coordinates and depth. In one or more embodiments, the starting point may be specified by the user or automatically obtained, such as by the surface unit. For example, the surface unit may provide the current location of the end of the borehole or where the drilling is to occur as the starting point.

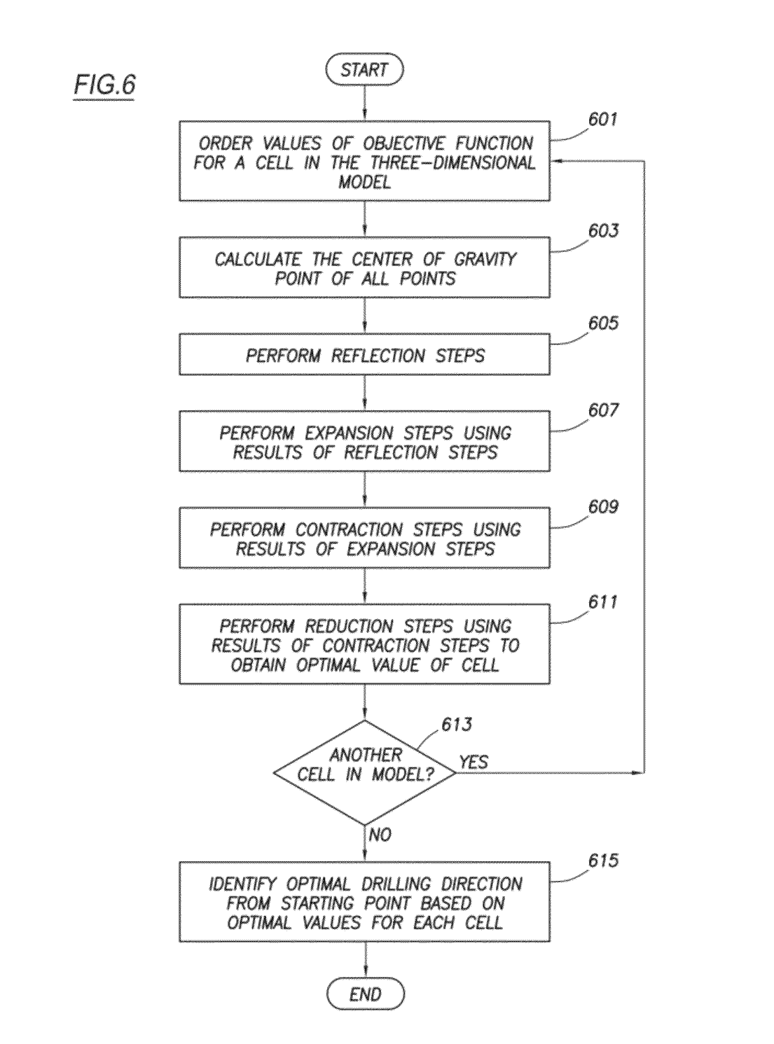

In 513, using the three-dimensional model and an objective function, a drilling direction is calculated from the starting point that minimizes stress or contrast between stresses in one or more embodiments. Specifically, the drilling direction that is calculated minimizes the amount of stress caused by drilling in the geographic region. Because the three-dimensional model is used to calculate drilling direction, not only are stresses and geologic formations along the path of the proposed borehole considered, but also other geologic features from entire geographic region are considered. In other words, the three-dimensional model provides a more comprehensive view of the earth's formations. Calculating a drilling direction is discussed below and in FIG. 6.

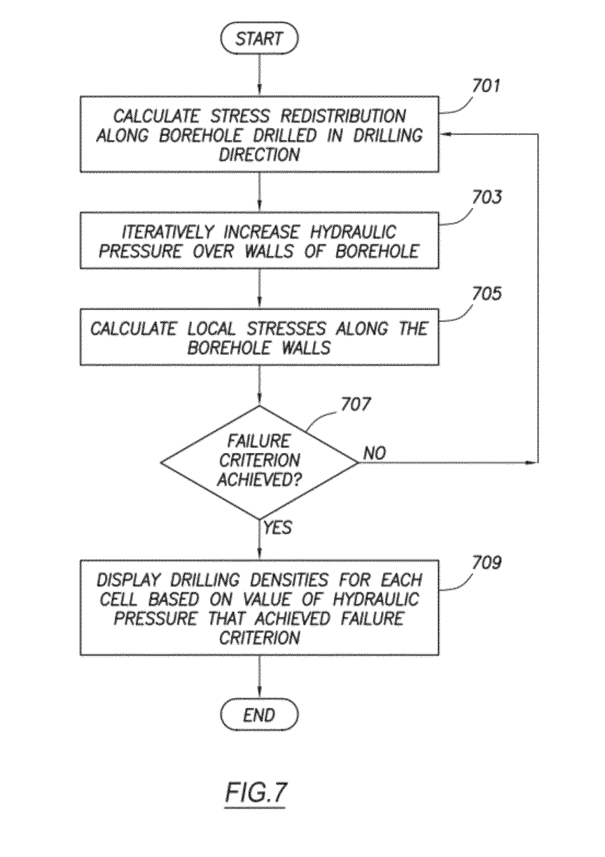

Continuing with FIG. 5, in 515, drilling densities are calculated using the three-dimensional model in one or more embodiments. The drilling density is the upper and lower bounds of equivalent hydraulic pressure acting over the borehole walls to create rock failure. In other words, the drilling density provides the minimum and maximum amount of mudweight that should be pumped when drilling in the drilling direction. Calculating the drilling densities is discussed below and in FIG. 7.

Continuing with FIG. 5, in 517, the drilling direction and the drilling densities are presented to the user in one or more embodiments. In one or more embodiments, the drilling densities and the drilling direction are presented by the visualization engine showing the three-dimensional model with the drilling direction and drilling densities. Thus, the user may view the drilling direction and drilling densities with graphic representations of other geologic formations and information about geologic formations to determine whether the drilling direction and the drilling densities should be approved.

In 519, a determination is made whether the drilling direction and the drilling densities are approved in one or more embodiments. Specifically, a determination is made whether the user approves of the drilling direction and the drilling densities. In one or more embodiments, the user may approve the drilling direction and drilling densities by selecting a user interface component of the visualization engine. The user that approves or disapproves of the drilling direction and the drilling densities may or may not be the same user that provides the starting point or another user that provides input to the computer system. If the user disapproves of the drilling direction and drilling densities, the flow proceeds to 513 in one or more embodiments. Although not shown in FIG. 3, if only disapproval of the drilling densities is received, then only the drilling densities may be recalculated. If the user approves of both the drilling direction and the drilling densities, the flow proceeds to 521 in one or more embodiments.

In 521, the oilfield is drilled in the drilling direction at the starting point using the drilling densities and according to the three-dimensional model in one or more embodiments. In other words, the calculations, which use the three-dimensional model, are directly used to drill the borehole, and eventually produce hydrocarbons in one or more embodiments. Drilling may include the computer system sending the drilling densities to the surface unit. The surface unit may provide instructions to the drilling equipment at the oilfield with the parameters of drilling. In one or more embodiments, the drilling direction and drilling densities may be provided to a user that may provide the information to the oilfield. In one or more embodiments, the drilling direction and drilling densities may be provided to the oilfield analysis application that may use the information for additional oilfield analysis.

FIG. 6 shows a flowchart for calculating drilling directions in one or more embodiments. Specifically, FIG. 6 shows only one example for calculating drilling directions in one or more embodiments. Other methods for calculating drilling directions may be used without departing from the scope of the claims.

In one or more embodiments, the details of the calculation involve minimizing the maximum principal stress, maximizing the minimum principal stress or minimizing the contrast between the maximum principal stress and the minimum principal stress, as a function of wellbore deviation and azimuth. In one or more embodiments, the aforementioned stresses are evaluated at the face of the borehole wall for a specific depth. An example function to minimize would be equation for hoop stress around a borehole:

$${σ}_{θ} = \frac{{σ}_{x}^{σ} + {σ}_{y}^{σ}}{2} ( 1 + \frac{{R}_{w}^{2}}{{r}^{2}} ) - \frac{{σ}_{x}^{σ} - {σ}_{y}^{σ}}{2} ( 1 + 3 \frac{{R}_{w}^{4}}{{r}^{4}} ) cos 2 θ - {r}_{xy}^{σ} ( 1 + 3 \frac{{R}_{w}^{4}}{{r}^{4}} ) sin 2 θ - {p}_{w} \frac{{R}_{w}^{2}}{{r}^{2}}$$

In the above equation, σ_{θ} is hoop stress around a wellbore. σₓ and σ_{y} are the stresses acting parallel and perpendicular to the projection of the well's azimuth to a plane transversally cutting the wellbore. Both σₓ and σ_{y} act parallel to this plane. R_{w} is the well's radius and r is the radius where the stress is being evaluated. When R_{w} and r are equal, the stress is evaluated at the face of the borehole.

In one or more embodiments, the minimization procedure is done following a Nelder-Mead or Downhill Simplex algorithm along a 2 dimensional inclination-azimuth space. In example, setting the previous equation as an objective function ƒ with the well's inclination and azimuth as variables, the optimum well inclination x can be obtained using the procedure specified in FIG. 6,

In 601, values of the objective function are ordered for a cell in the three-dimensional model. For example, the ordered values may be ƒ(x₁)≦ƒ(x₂)≦ . . . ≦ƒ(xₙ₊₁). For a minimization process of n variables, x₁ to xₙ₊₁ are n+1 points which are sequentially changed in order to reach a final point where ƒ(final point) is a minimum. This may be achieved by the sequential application of the four processes of the Nelder-Mead algorithm. Namely, the four processes are reflection, expansion, contraction, and multiple contractions. In the following methods, the variables σ, ρ, γ and α are used. σ, ρ, γ and α are four user defined constants that the minimization algorithm may use. The four user defined constants govern the behavior (e.g., speed and rate of convergence) of the four main processes of the algorithm (i.e., reflection, expansion, contraction, and multiple contraction).

In 603, the center of gravity point of all points except the final point in the ordering of 601 is calculated. In one or more embodiments, the center of gravity point may be xₒ and the final point may be xₙ₊₁. The center of gravity is the average value of all of the points.

In 605, reflection steps are performed in one or more embodiments. The reflection steps may include, for example, computing a reflected point (i.e., “xᵣ”) using the equation xᵣ=x₀+α(x₀−(xₙ₊₁)). If the reflected point is better than the second worst, but not better than the best, (i.e., ƒ(x₁)≦ƒ(xᵣ)<ƒ(xₙ)), then a new simplex is obtained by replacing the worst point (i.e., xₙ₊₁) with the reflected point xᵣ, and the reflection steps are repeated. Otherwise, the flow continues to 607.

In 607, expansion steps are performed in one or more embodiments. The expansion steps may include determining if the reflected point is the best point so far in the calculations (i.e., ƒ(xᵣ)≦ƒ(x₁)), than an expansion point may be computed. The expansion point may be computed using the equation, xₑ=x₀+γ*(x₀−(xₙ₊₁)). If the expansion point is better than the reflected point (i.e., ƒ(xₑ)<ƒ(xᵣ)), then a new simplex is obtained by replacing the worst point (i.e., xₙ₊ᵢ) with the expansion point xₑ, and the expansion steps are repeated. Otherwise, if expansion point is not better than the reflected point and better than the second worst point, then a new simplex is obtained by replacing the worst point (i.e., xₙ₊₁) with the reflected point xᵣ, and the expansion steps are repeated. Otherwise the flow continues to 609.

In 609, contraction steps are performed in one or more embodiments. During the contraction steps, the reflection point is better than the second worst point (i.e., ƒ(xᵣ)≧ƒ(xₙ)). The contracted point (i.e., “x_{c}”) may be computed using the equation, x_{c}=xₙ₊₁+ρ*(x₀−(xₙ₊₁)). If the contracted point is better than the worst point (i.e., ƒ(x_{c})<ƒ(xₙ₊₁)), then a new simplex is obtained by replacing the worst point (i.e., xₙ₊₁) with the contraction point x_{c}, and the contraction steps are repeated. Otherwise, the flow continues to 611.

In 611, reduction steps are performed viii one or more embodiments. During the reduction steps, for all points except for the best point, the point is replaced with xᵢ=x₁+σ*(x₀−(xₙ₊₁)) for all i {2, . . . , n+1}.

In 613, a determination is made whether another cell exists in the model. If another cell exists in the model, then the flow may proceed to 601 for the next cell. Although not shown in FIG. 6, the calculations for each of the cells may be performed in serial or in parallel. If another cell is not in the model, then the flow proceeds to 615.

In 615, the optimal drilling direction is identified from the starting point based on the optimal values for each of the cells. Specifically, the best point calculated in 601-611 is the optimal drilling direction for the cell. The optimal drilling direction of each of the cells defines the path from the starting point to the reservoir. In one or more embodiments, the method ends when the minimization process may reach a maximum number of iterations. The maximum number of iterations may be preconfigured or user defined.

FIG. 7 shows a flowchart for calculating drilling densities in one or more embodiments. By way of an overview, in one or more embodiments, the calculation of the critical mud densities (i.e., drilling densities) is performed independently at each cell. The calculation is performed by transforming the local acting stress state onto a new reference coordinate system that is defined by a prescribed drilling inclination and azimuth (possibly from a safest drilling direction cube). The stress redistribution along an arbitrary borehole is calculated analytically. Further, the equivalent hydraulic pressure over the face of the borehole is iterated until a given failure criterion is achieved.

The pressure values of the equivalent hydraulic pressure when failure criterion is achieved provide the analytical limits to define the onset of failure. In one or more embodiments, the pressure values are calculated both for shear and tensile mechanisms, thereby providing a lower and upper drilling fluid density limits, respectively, in one or more embodiments.

Turning to FIG. 7, in 701, stress redistribution is calculated along the borehole drilled in the drilling direction. Specifically, at this stage, as discussed above, the drilling direction of each of the cells in FIG. 6 together defines a path. For the calculations of FIG. 7, a borehole is assumed to be drilled that follows the path. Stress redistribution is calculated along the assumed borehole. In one or more embodiments, a strain/stress model is used to calculate stress redistribution. The strain/stress model may be obtained from any source. For example, the strain/stress model may use a finite element method, such as an industry standard for advanced stress modeling.

In 703, the hydraulic pressure over the walls of the borehole is calculated in one or more embodiments. Specifically, an assumption is made that the hydraulic pressure is increased to a new value. The amount of the increase may be a configurable parameter of the oilfield three-dimensional simulator application in one or more embodiments.

In 705, local stresses along the borehole walls are calculated in one or more embodiments. In one or more embodiments, the local stresses may be calculated using Kirsh equations. However, the calculations may be performed using any stress modeling technique, such as those found in E. Fjaer et al., Petroleum Related Rock Mechanics, (2nd Ed., Elsevier B.V., 2008) (1992).

In 707, a determination is made whether a failure criterion is achieved. Specifically, a determination is made whether the amount of local stresses exceeds the stresses for the borehole causing failure or warning of a failure of the borehole. In particular, in one or more embodiments, the failure criterion may indicate an amount of local stresses sufficient to compromise the integrity of the borehole. Alternatively or additionally, the failure criterion may indicate an amount of local stresses that is sufficient to cause failure of the borehole. The determination may be made by comparing the local stresses with a defined maximum stresses for the geologic structures. The maximum stresses may be in the three-dimensional model or separate from the three-dimensional model. If the local stresses are less than the maximum stresses, then the flow returns to 701. If the local stresses are greater than maximum stress than the flow proceeds to 709.

In 709, the drilling densities are displayed for each cell based on value of hydraulic pressure that achieved failure criterion in one or more embodiments. The drilling densities may be displayed in the three-dimensional model in one or more embodiments. Specifically, the drilling densities may be displayed using numerical values and/or color coding in the three-dimensional model. Displaying the drilling densities may be performed, for example, by the visualization engine.

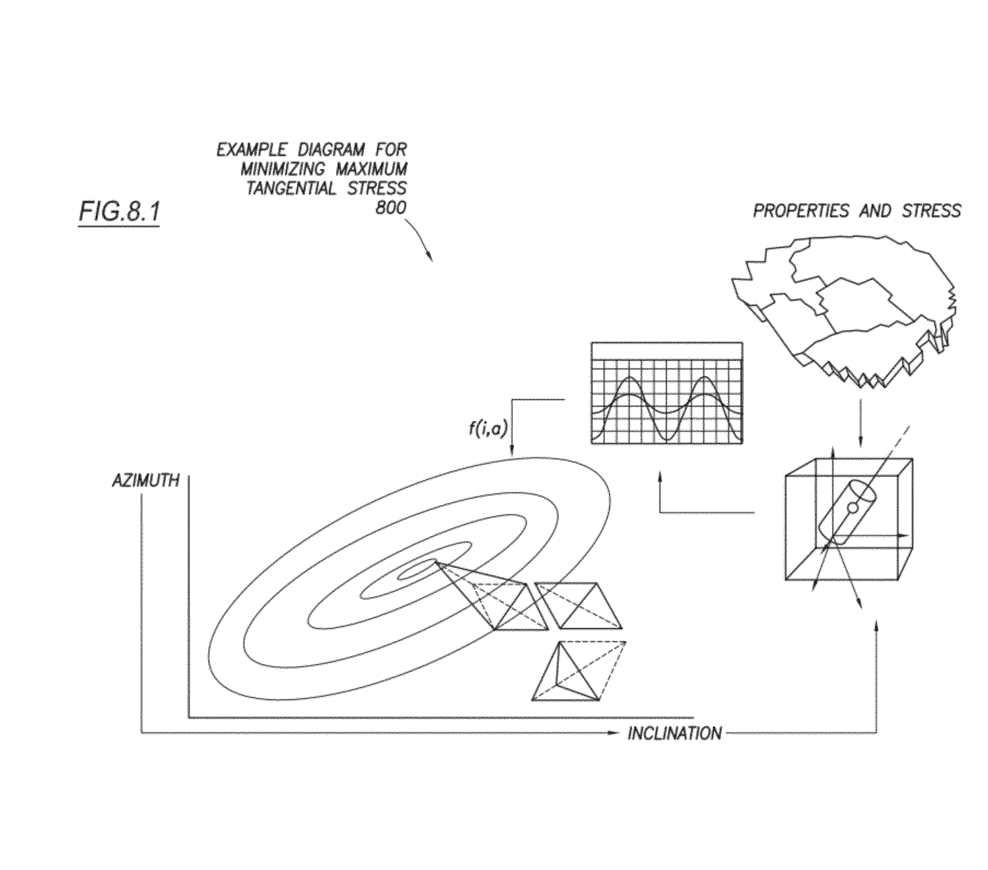

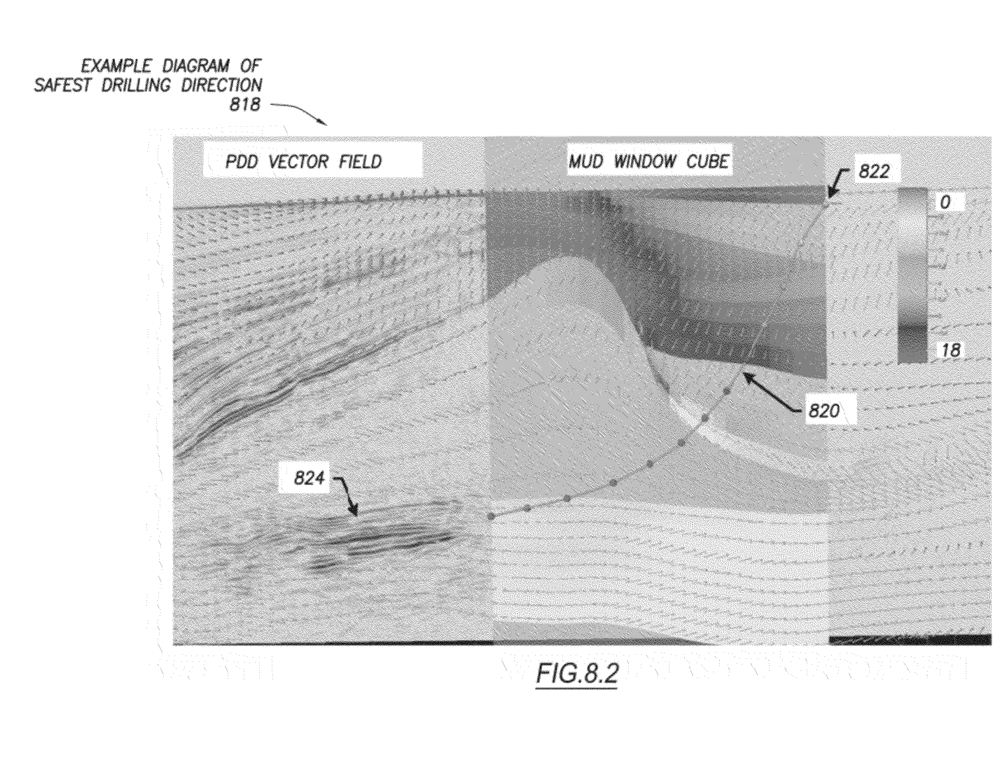

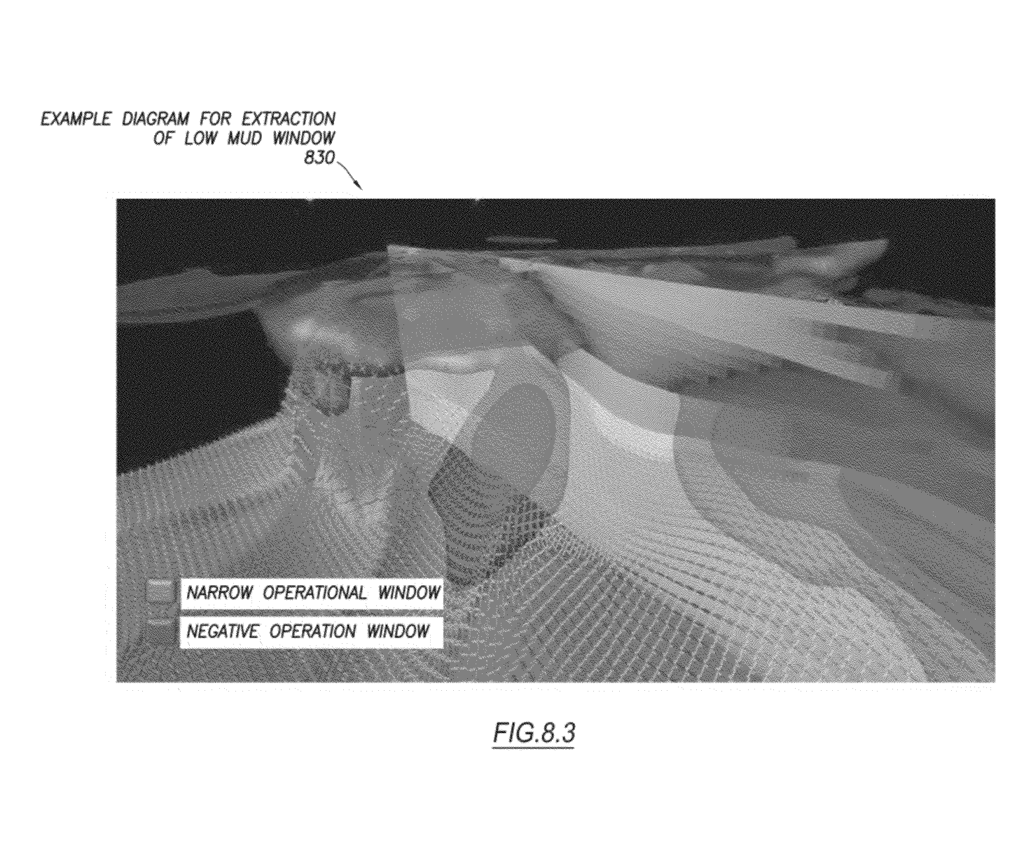

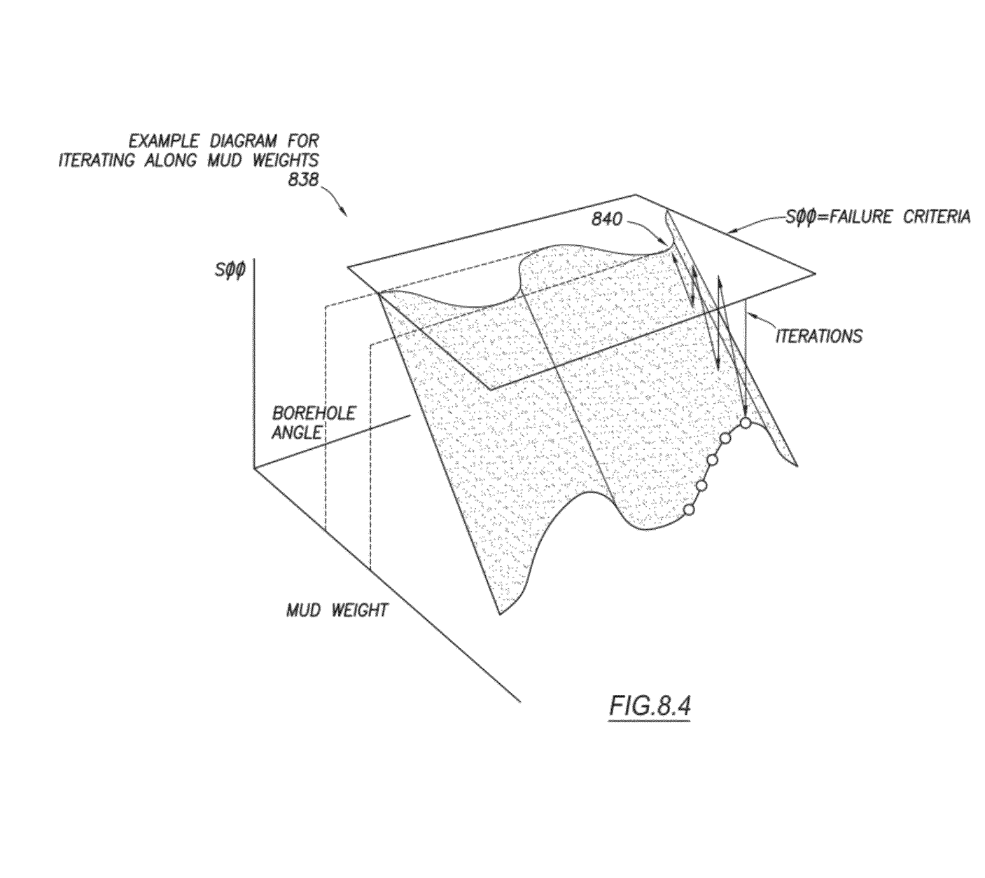

FIG. 8.1-8.4 show examples in accordance with one or more embodiments of the three-dimensional modeling. The following examples are for explanatory purposes only and not intended to limit the scope of the claims.

FIG. 8.1 shows an example diagram for minimizing the maximum tangential stress (800) around a wellbore as a function of inclination and azimuth.

FIG. 8.2 shows an example diagram of the safest drilling direction (818) imposed over a seismic line. Specifically, in one or more embodiments, the safest drilling directions model can be displayed as a discrete vector field. To display the safest drilling directions model, the inclination-azimuth combination may be transformed into a unit vector placed at the center of the corresponding cell. The transformation allows the user to intuitively guide the design of a drilling trajectory, while accounting for the geomechanical considerations of the geologic region. In one or more embodiments, the path (820) (i.e., trajectory) defined by the drilling directions starts at starting point (822) and ends at reservoir (824). In FIG. 8.2, as specified in the legend, the different regions represent different mud densities in pounds per gallon. As shown in FIG. 8.2, the mud densities are on a scale that from 0 to 18 in one or more embodiments.

FIG. 8.3 shows example diagram for an extraction of low mud window (830) (i.e., the difference between minimum and maximum drilling densities) in the three-dimensional model. Specifically, FIG. 8.3 shows extracted zones of low mud window to exhibit volumes within the three-dimensional model of higher risk zones. The arrows in FIG. 8.3 depict a direction of principal stresses in the model.

FIG. 8.4 shows an example diagram for iterating along the mud weights (838) to achieve failure criterion along the borehole wall. Specifically, stress redistribution along an arbitrary borehole is calculated analytically and the equivalent hydraulic pressure over the face of the borehole is iterated until the given failure criterion is achieved. In FIG. 8.4, the failure criterion is achieved at point (840).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for three-dimensional modeling of parameters for oilfield drilling, comprising:
generating a three-dimensional model of an underground geological region;
receiving a starting point for the oilfield drilling;
calculating, using the three-dimensional model and an objective function, a drilling direction from the starting point;
calculating, using the three-dimensional model, drilling densities for drilling from the starting point; and
presenting the drilling direction and the drilling densities.

2. The method of claim 1, wherein generating the three-dimensional model comprises:
adjusting a one-dimensional model to obtain information for the three-dimensional model; and
building, using the information, the three-dimensional model.

3. The method of claim 1, wherein generating the three-dimensional model comprises:
obtaining actual events along an existing borehole for an existing wellbore;
extracting, from the three-dimensional model, a synthetic one-dimensional model along a wellbore trajectory matching the existing borehole;
obtaining predicted events along the synthetic one-dimensional model; and
validating the three-dimensional model when the predicted events are within a threshold difference to the actual events.

4. The method of claim 1, further comprising:
receiving an approval of the drilling direction and the drilling densities; and
in response to receiving the approval, performing a drilling operation based upon the drilling direction and the drilling densities.

5. The method of claim 4, wherein performing the drilling operation comprises drilling in a direction corresponding to the drilling direction using the drilling densities and according to the three-dimensional model.

6. The method of claim 1, wherein calculating the drilling direction from the starting point comprises:
for each cell of a plurality of cells in the three-dimensional model:
ordering a plurality of values of the objective function for a cell in the three-dimensional model;
calculating a center of gravity for the plurality of values;
performing at least one reflection step on the plurality of values to obtain a reflection step result;
performing, using the reflection step result, at least one expansion step on the plurality of values to obtain an expansion step result;
performing, using the expansion step result, at least one contraction step to obtain a contraction step result; and
performing, using the contraction step result, at least one reduction step to obtain an optimal value of the plurality of values for the cell; and
identifying the drilling direction based on the optimal value of each cell.

7. The method of claim 1, wherein calculating drilling densities for drilling from the starting point comprises:
calculating a stress distribution along a borehole drilled in the drilling direction to determine whether a failure criterion has been achieved; and
until a failure criterion is achieved:
iteratively increasing hydraulic pressure over walls of the borehole;
recalculating the stress distribution along the walls of the borehole; and
determining whether the most recently calculated stress distribution achieves the failure criterion.

8. The method of claim 7, wherein the failure criterion specifies an amount of local stresses sufficient to compromise an integrity of the borehole.

9. The method of claim 7, wherein the failure criterion specifies an amount of local stresses sufficient to cause failure of the borehole.

10. A system for three-dimensional modeling of parameters for oilfield drilling, comprising:
an oilfield three-dimensional simulator application executing on a computer processor and configured to:
generate a three-dimensional model of an underground geological region; and
an oilfield analysis application executing on the computer processor and configured to:
receive a starting point for the oilfield drilling;
calculate, using the three-dimensional model and an objective function, a drilling direction from the starting point;
calculate, using the three-dimensional model, drilling densities for drilling from the starting point; and
present the drilling direction and the drilling densities.

11. The system of claim 10, wherein the oilfield three-dimensional simulator application comprises a reservoir simulator and a geomechanical simulator.

12. The system of claim 10, wherein the oilfield three-dimensional simulator application comprises a visualization engine configured to:
display the three-dimensional model; and
receive input from a user on the three-dimensional model.

13. The system of claim 10, further comprising:
a storage repository configured to store geological data, seismic logs, pore pressure reduction effects, and the three-dimensional model.

14. The system of claim 10, wherein generating the three-dimensional model comprises:
adjusting a one-dimensional model to obtain information for the three-dimensional model; and
building, using the information, the three-dimensional model.

15. The system of claim 10, wherein generating the three-dimensional model comprises:
obtaining actual events along an existing borehole for an existing wellbore;
extracting, from the three-dimensional model, a synthetic one-dimensional model along a wellbore trajectory matching the existing borehole;
obtaining predicted events along the synthetic one-dimensional model; and
validating the three-dimensional model when the predicted events are within a threshold difference to the actual events.

16. The system of claim 10, further comprising:
production equipment configured to:
drill in the drilling direction using the drilling densities and according to the three-dimensional model; and
a surface unit configured to control the production equipment and receive the drilling direction and the drilling densities from the oilfield analysis application.

17. The system of claim 10, wherein calculating the drilling direction from the starting point comprises:
for each cell of a plurality of cells in the three-dimensional model:
ordering a plurality of values of the objective function for a cell in the three-dimensional model;
calculating a center of gravity for the plurality of values;
performing at least one reflection step on the plurality of values to obtain a reflection step result;
performing, using the reflection step result, at least one expansion step on the plurality of values to obtain an expansion step result;
performing, using the expansion step result, at least one contraction step to obtain a contraction step result; and
performing, using the contraction step result, at least one reduction step to obtain an optimal value of the plurality of values for the cell; and
identifying the drilling direction based on the optimal value of each cell.

18. A computer readable storage medium comprising computer readable program code embodied therein for causing a computer system to perform a method for three-dimensional modeling of parameters for oilfield drilling, comprising:
generating a three-dimensional model of an underground geological region;
receiving a starting point for the oilfield drilling;
calculating, using the three-dimensional model and an objective function, a drilling direction from the starting point;
calculating, using the three-dimensional model, drilling densities for drilling from the starting point; and
presenting the drilling direction and the drilling densities.

19. The computer readable storage medium of claim 18, wherein generating the three-dimensional model comprises:
obtaining actual events along an existing borehole for an existing wellbore;
extracting, from the three-dimensional model, a synthetic one-dimensional model along a wellbore trajectory matching the existing borehole;
obtaining predicted events along the synthetic one-dimensional model; and
validating the three-dimensional model when the predicted events are within a threshold difference to the actual events.

20. The computer readable storage medium of claim 18, wherein calculating the drilling direction from the starting point comprises:
for each cell of a plurality of cells in the three-dimensional model:
ordering a plurality of values of the objective function for a cell in the three-dimensional model;
calculating a center of gravity for the plurality of values;
performing at least one reflection step on the plurality of values to obtain a reflection step result;
performing, using the reflection step result, at least one expansion step on the plurality of values to obtain an expansion step result;
performing, using the expansion step result, at least one contraction step to obtain a contraction step result; and
performing, using the contraction step result, at least one reduction step to obtain an optimal value of the plurality of values for the cell; and
identifying the drilling direction based on the optimal value of each cell.
